(19) United States
(12) Patent Application Publication
(10) Pub. No.: US 2019/0294181 A1
(43) Pub. Date: Sep. 26, 2019

(54) VEHICLE, MANAGEMENT DEVICE, AND VEHICLE MANAGEMENT SYSTEM

(71) Applicant: NIDEC-SHIMPO CORPORATION, Kyoto (JP)

(72) Inventors: Ryoji Ohno, Kyoto (JP); Takeshi Sakai, Kyoto (JP)

(73) Assignee: NIDEC-SHIMPO CORPORATION, Kyoto (JP)

(21) Appl. No.: 16/361,190

(22) Filed: Mar. 21, 2019

(30) Foreign Application Priority Data
Mar. 23, 2018 (JP) 2018-056473

(51) Int. Cl. G05D 1/02; G05D 1/00

(52) U.S. Cl. CPC G05D 1/0297; G05D 1/0238; G05D 1/0088

(57) ABSTRACT

The vehicle management system has a plurality of vehicles capable of moving autonomously, a management device, and a display. The management device has a first communication circuit for communicating with each vehicle and a processing circuit for determining a traveling path for each vehicle and transmitting an instruction indicating the traveling path to each vehicle via the first communication circuit. Each vehicle has a second communication circuit, an obstacle sensor, and a controller for causing the vehicle to move according to the instruction received via the second communication circuit. When the obstacle sensor has detected an obstacle on the path, the controller notifies the presence of the obstacle to the outside via the second communication circuit. Upon receiving the notification indicating the presence of the obstacle from any one the plurality of vehicles, the processing circuit of the management device instructs the display to indicate the presence of the obstacle.

### CROSS REFERENCE TO RELATED APPLICATIONS

This application claims the priority benefit of Japanese Patent Application No. 2018-056473, filed on Mar. 23, 2018. The entirety of the above-mentioned patent application is hereby incorporated by reference herein and made a part of this specification.

### TECHNICAL FIELD

The present disclosure relates to a vehicle, a management device, and a vehicle management system.

### DESCRIPTION OF THE RELATED ART

Research and development of vehicles, such as automated guided vehicles or mobile robots, are under way. For example, Japanese Laid-Open Patent Publications Nos. 2009-223634, 2009-205652 and 2005-242489 each disclose a system that controls movement of a plurality of autonomous vehicles so that the respective vehicles do not collide with one another.

### SUMMARY

An embodiment of the present disclosure provides a technology for more smoothly navigating a plurality of autonomously movable vehicles.

According to an exemplary embodiment of the present disclosure, a vehicle capable of moving autonomously is provided and includes: a communication circuit; an obstacle sensor, configured to detect an obstacle; and a controller, configured to cause the vehicle to move in accordance with an instruction received via the communication circuit. When the obstacle sensor detects an obstacle on a traveling path of the vehicle, the controller notifies presence of the obstacle to an outside via the communication circuit.

With a plurality of vehicles according to an embodiment of the present disclosure, when one of the vehicles detects an obstacle being present on a traveling path, the vehicle notifies the presence of the obstacle to the outside via the communication circuit thereof. A management device and/or the other vehicles having received the notification can recognize the presence of the obstacle. Hence, for example, an avoidance path can be determined, whereby navigation control by a vehicle management system can be made smoother.

### BRIEF DESCRIPTION OF THE DRAWINGS

FIG. 1 is a view schematically showing a configuration of a vehicle management system according to an exemplary embodiment of the present disclosure.

FIG. 2A is a view showing an example in which no obstacle is present on the traveling path of a vehicle.

FIG. 2B is a view showing an example in which an obstacle is present between a marker M₁ and a marker M₂ on the traveling path of the vehicle.

FIG. 2C is a view showing a map displayed on an external display of a management device and also showing an icon corresponding to the obstacle.

FIG. 2D is a view showing an example of an avoidance path of the vehicle.

FIG. 2E is a view showing an example of an avoidance path.

FIG. 2F is a view showing another example of the avoidance path.

FIG. 3 is a view showing an example of data indicating the traveling path of each vehicle managed by the management device.

FIG. 4A is a flow chart showing an example operation of a processing circuit of the management device.

FIG. 4B is a flow chart showing an example operation of a controller of a vehicle.

FIG. 5A is a flow chart showing an example operation of the processing circuit of the management device in the case where the obstacle disappears.

FIG. 5B is a flow chart showing an example operation of the controller of the vehicle in the case where the obstacle disappears.

FIG. 6 is a view showing an outline of a control system for controlling the travel of respective AGVs according to the present disclosure.

FIG. 7 is a view showing an example of an area S in which AGVs are present.

FIG. 8A is a view showing an AGV and a trailer before being connected together.

FIG. 8B is a view showing an AGV and a trailer having been connected together.

FIG. 9 is a view showing an external appearance of an exemplary AGV according to the present embodiment.

FIG. 10A is a view showing a first example hardware construction of the AGV.

FIG. 10B is a view showing a second example hardware construction of the AGV.

FIG. 11A is a view showing the AGV generating a map while moving.

FIG. 11B is a view showing the AGV generating a map while moving.

FIG. 11C is a view showing the AGV generating a map while moving.

FIG. 11D is a view showing the AGV generating a map while moving.

FIG. 11E is a view showing the AGV generating a map while moving.

FIG. 11F is a view schematically showing a part of a completed map.

FIG. 12 is a view showing an example in which one floor map is composed of a plurality of partial maps.

FIG. 13 is a view showing an example hardware construction of a navigation management device.

FIG. 14 is a schematic view showing an exemplary traveling path of the AGV that is determined by the navigation management device.

### DESCRIPTION OF EMBODIMENTS

### Terms

Before the explanation of an embodiment of the present disclosure, the definitions of the terms used in this specification will be explained.

An “automated guided vehicle” (AGV) means an unguided vehicle configured to automatically travel to a designated place. Goods may be loaded on and unloaded from the main body of the AGV by manpower or automatically. The notion of an “automated guided vehicle” includes an unmanned tractor unit and an unmanned forklift.

The term “unmanned” means a state in which no person is required to steer a vehicle, and does not preclude the vehicle from carrying a person(s) (for example, a person(s) who will load and unload cargo).

An “unmanned tractor unit” is an unguided vehicle that travels automatically to a designated place while dragging a cart, onto/from which cargo is loaded and unloaded by manpower or automatically.

An “unmanned forklift” is an unguided vehicle equipped with a mast along which a fork for transferring cargo, etc., is raised or lowered, such that cargo is loaded on the fork automatically; the vehicle automatically travels to a designated place; and the cargo is loaded and unloaded automatically.

An “unguided vehicle” is a vehicle equipped with one or more electric motors or one or more engines for rotating the wheels thereof.

A “vehicle” is a device that is capable of traveling while being loaded with a person(s) or cargo, and is equipped with a driving device, such as wheels for generating traction for travel, a biped or multiped device, or a propeller. The term “vehicle” in the present disclosure includes not only an automated guided vehicle in a limited sense but also a mobile robot, a service robot, and a drone.

The notion of “automated travel” includes: travel based on instructions from a navigation management system; and autonomous travel by a control device within the automated guided vehicle. The navigation management system may be a computer to which the automated guided vehicle is connected via communication s technologies. Autonomous travel includes not only traveling of the automated guided vehicle to a destination along a predetermined path, but also traveling in a manner of following a moving target to be followed. Furthermore, the automated guided vehicle may temporarily perform manual travel on the basis of instructions from a worker. In the general sense of the term, “automated travel” should include both “guided type” travel and “guideless type” travel; for the purpose of the present disclosure, however, “automated travel” will mean “guideless type” travel.

The “guided type” is said of a system in which guiding signs are provided continuously or continually, such that an automated guided vehicle is guided by the use of the guiding signs.

The “guideless type” is said of a system in which an automated guided vehicle is guided without any guiding signs being provided. The automated guided vehicle according to an embodiment of the present disclosure is equipped with a localization device and can travel as the guideless type.

A “localization device” is a device for estimating its own position on an environment map on the basis of sensor data acquired by an external sensor, such as a laser range finder.

An “external sensor” is a sensor for sensing the external state of a vehicle. Examples of external sensors include a laser range finder (also referred to as a range-finding sensor), a camera (or an image sensor), a LIDAR (Light Detection and Ranging) device, a millimeter wave laser, and a magnetic sensor.

An “internal sensor” is a sensor for sensing the internal state of a vehicle. Examples of internal sensors include a rotary encoder (hereafter may be simply referred to as an “encoder”), an acceleration sensor, and an angular acceleration sensor (for example, a gyro sensor).

“SLAM” is an abbreviation of Simultaneous Localization and Mapping, and means that localization and environment map generation are performed simultaneously.

### Exemplary Embodiments

Exemplary constructions for vehicles and vehicle management systems according to embodiments of the present disclosure will be described below referring to the accompanying drawings. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

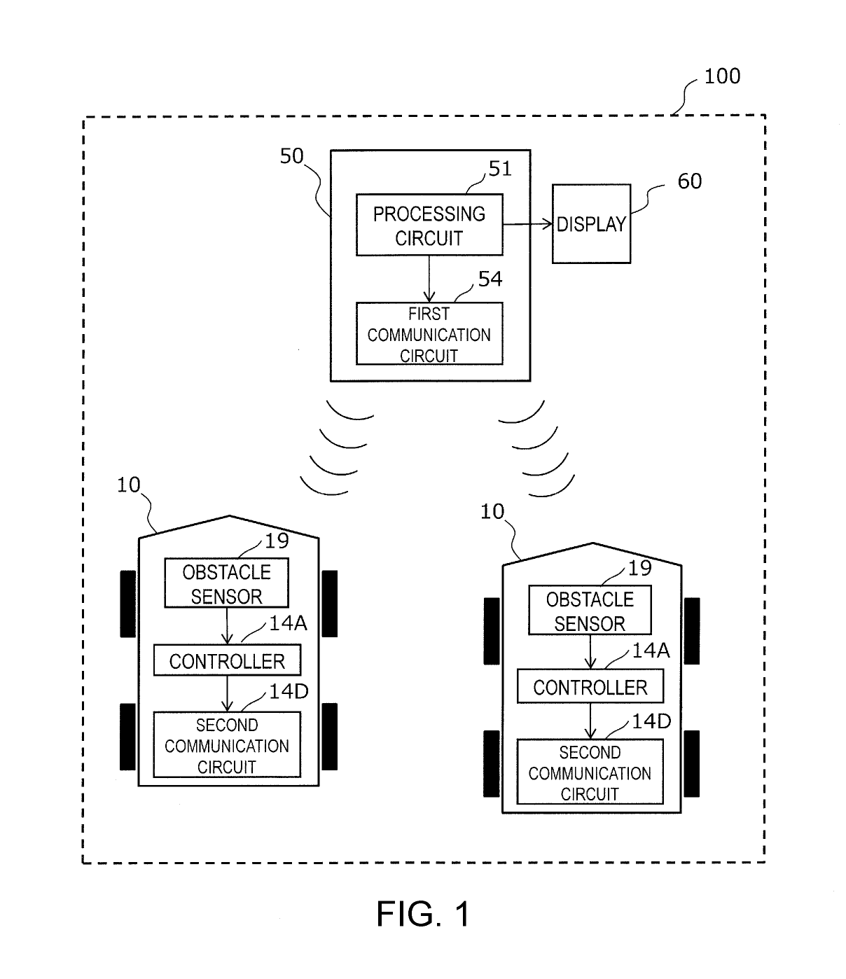

FIG. 1 is a view schematically showing a configuration of a vehicle management system 100 according to an exemplary embodiment of the present disclosure. The vehicle management system 100 includes: a plurality of vehicles 10 capable of traveling autonomously; a navigation management device (which hereafter may simply be referred to as the “management device”) 50 configured to manage navigation of the plurality of vehicles 10; and a display 60. The display 60 may be any arbitrary display, such as a liquid crystal display or an organic EL display. The display 60 may be included in the management device 50. For example, in the case where the management device 50 is a desktop PC, the display 60 may be an external monitor. In the case where the management device 50 is a laptop PC, the display 60 may be a built-in monitor.

FIG. 1 illustrates two vehicles 10, as an example. The vehicle management system 100 may include three or more vehicles 10. In this embodiment, the vehicle 10 is an automated guided vehicle (AGV). In the following description, the vehicle 10 may also be referred to as the “AGV 10”. The vehicle 10 may be other kinds of vehicles, such as a biped or multilegged robot, a hovercraft or a drone.

The management device 50 includes a first communication circuit 54 configured to communicate with the respective plurality of vehicles 10 via a network and a processing circuit 51 configured to control the first communication circuit 54. The processing circuit 51 determines traveling paths of the respective plurality of vehicles 10, and transmits instructions indicating the traveling paths of the respective vehicles 10 to the plurality of vehicles 10 via the first communication circuit 54. The traveling path may be determined independently for each vehicle 10; alternatively, it may be possible for all vehicles 10 to travel along the same traveling path.

The management device 50 transmits “a notification indicating a traveling path” to each vehicle 10. For example, the “notification indicating a traveling path” may include the positions of a plurality of points on the path from an initial position to a destination position, or may only include the position of a next point. In this description, such a point(s) may be referred to as “a marker(s)”. The markers may be set at every distance of approximately several tens of centimeters (cm) to several meters (m) along the traveling path of each vehicle 10. The markers may alternatively be set at every distance of approximately several tens of meters, i.e., longer than several meters.

Each of the plurality of vehicles 10 travels along a traveling path in accordance with an instruction(s) from the management device 50. In a typical example, each vehicle 10 includes a storage device configured to store environment map data (which may simply be referred to as an “environment map”) and an external sensor configured to scan the environment and output sensor data for each scanning. In that case, each vehicle 10 travels along the traveling path while estimating its own position and pose (as defined below) by matching the sensor data against the environment map data.

Each vehicle 10 has a function of detecting an obstacle on the traveling path and a function of notifying presence of the detected obstacle to the outside. Each vehicle 10 includes a second communication circuit 14d capable of communicating with the first communication circuit 54 via a network, an obstacle sensor 19 configured to detect the obstacle, and a controller 14a configured to control the travel and communication of the vehicle 10. The controller 14a causes the vehicle 10 to travel along the traveling path determined by the processing circuit 51 by controlling a driving device which is not shown. When an obstacle is detected on the traveling path by the sensor 19, the controller 14a notifies the presence of the detected obstacle to the outside.

The notification indicating the presence of the obstacle may include, for example, data indicating the position at which the obstacle is present, the size of the obstacle, and/or information on the area occupied by the obstacle.

Upon receiving a notification indicating the presence of an obstacle from any one of the plurality of vehicles 10, the processing circuit 51 of the management device 50 causes display 60 to indicate the presence of the obstacle.

The management device 50 may further include a storage device configured to store data of a map. The map may be displayed on the display 60. In the case where the vehicle 10 has transmitted data indicating the presence position of the obstacle, the processing circuit 51 displays, on the display 60, information indicating that the obstacle is present, e.g., an icon indicating the obstacle, at the position on the map corresponding to the presence position of the obstacle. With this indication on the map, an operator of the management device 50 can easily recognize where the obstacle is actually present.

Upon receiving a notification indicating the presence of an obstacle from any one of the plurality of vehicles 10, the processing circuit 51 of the management device 50 changes the traveling path of the vehicle 10 that has transmitted the notification. Alternatively, upon determining that the obstacle is present on the traveling path of another vehicle 10 which is not the vehicle 10 that has transmitted the notification, the processing circuit 51 changes the traveling path of this other vehicle 10.

An operation in the case where the signal indicating a traveling path includes information indicating the positions of a plurality of points (markers) on the path will be described as an example. When a signal indicating the presence of an obstacle is transmitted from any one of the plurality of vehicles 10, the processing circuit 51 changes the traveling path of at least the vehicle 10 that has transmitted the notification. More specifically, the processing circuit 51 specifies two adjacent points between which the obstacle is located and determines an avoidance path excluding the path connecting the specified two points. Furthermore, the processing circuit 51 determines whether the path connecting the specified two points is included in the traveling path of another vehicle 10; if the path is included, the processing circuit 51 determines an avoidance path excluding the path connecting the specified two points.

Through the above-mentioned operation, each vehicle 10 can smoothly travel along a new path without being affected by the obstacle. When a vehicle 10 finds an obstacle, an instruction indicating an avoidance path for avoiding the obstacle is transmitted from the management device 50. Thus, navigation control by the vehicle management system can be made smoother.

However, the management device 50 is not always required to determine avoidance paths. Since the vehicle 10 can travel autonomously, the vehicle can find an avoidance path on its own. For example, the controller 14a of the vehicle 10 may change its previous traveling path so as to travel in the direction in which the obstacle is not present, by using the obstacle sensor. As a result, if the vehicle 10 has found a traveling path to the position of the next target marker, the vehicle 10 may transmit the obstacle avoidance path (i.e., the altered traveling path) to the management device 50. Moreover, in order to reduce the processing load on the management device 50 as much as possible, in the case where the vehicle 10 has found an obstacle, the vehicle 10 may transmit the notification indicating the presence of the obstacle to the other vehicles 10 (rather than to the management device 50), or may transmit the notification to both the other vehicles 10 and the management device 50. Any other vehicles 10 that are located at relatively short distances where wireless communication is possible can know the presence of the obstacle promptly without using the management device 50. The other vehicles 10 may also operate in a manner of avoiding the obstacle autonomously.

Even after transmitting the presence of the obstacle, the vehicle 10 continues obstacle detection processing using the obstacle sensor 19. When the obstacle has been removed, the vehicle 10 can detect disappearance of the obstacle, and the controller 14a can notify the disappearance of the obstacle to the outside via the communication circuit. Upon receiving the notification indicating the disappearance, the processing circuit 51 clears the indication of the obstacle on the display 60. Thus, the operator of the management device 50 can visually recognize disappearance of the obstacle on the display 60.

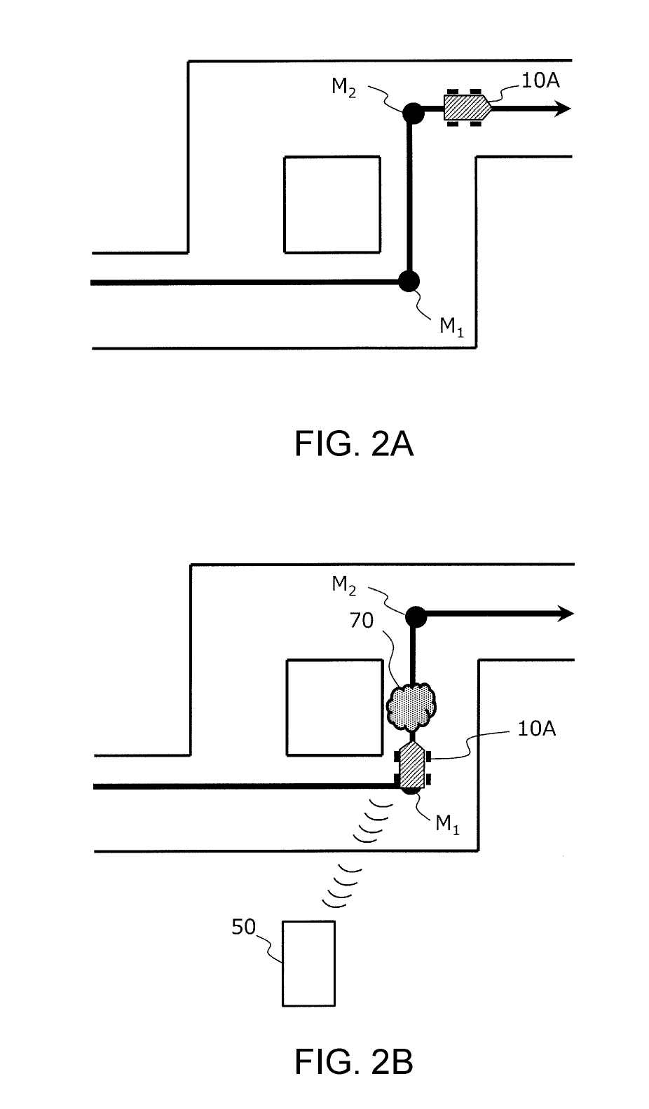

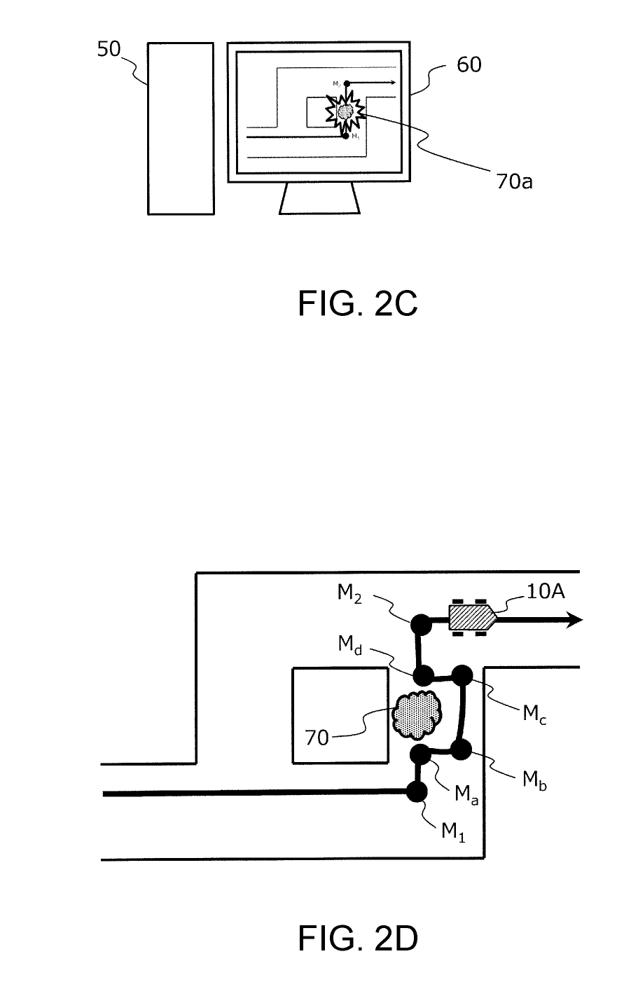

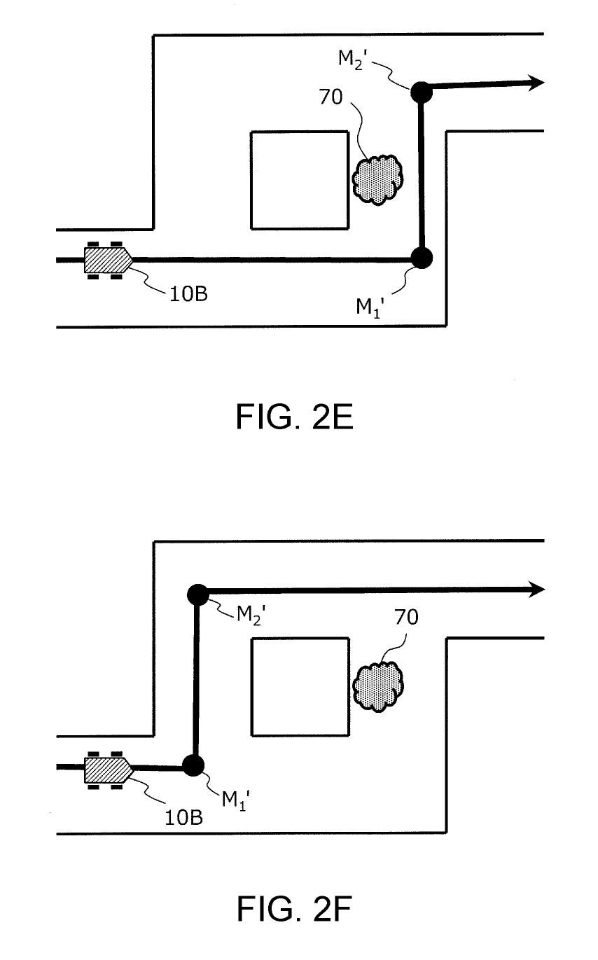

Example operations at the time of the change of the path will be described below by referring to FIGS. 2A to 2F. In this example, it is assumed that the “traveling path” is specified by information indicating the positions of a plurality of points (i.e., markers) on the path from an initial position to a destination position, and that the “notification indicating the presence of the obstacle” includes information indicating the position of the obstacle.

FIG. 2A shows an example in which no obstacle is present on the traveling path of the vehicle 10A. In this case, the vehicle 10A travels along a preset traveling path (indicated by a kinked arrow line in the figure). More specifically, the vehicle 10A sequentially follows a plurality of markers designated by the processing circuit 51 of the management device 50 (only the markers M₁ and M₂ are shown as examples in FIG. 2A), and travels from the initial position to the destination position. The travel between the markers is linear. The vehicle 10A may acquire the position information of all markers on the traveling path in advance. In another example, the vehicle 10A may request the management device 50 for the position information of a next marker when each time the vehicle 10A reaches a marker.

FIG. 2B shows an example in which an obstacle 70 is present between the marker M₁ and the marker M₂ on the traveling path of the vehicle 10A. The obstacle 70 is not an object that is present on the environment map, and may be, for example, cargo, a person or another vehicle. In the traveling path of the vehicle 10A which has been determined in advance, any such obstacle is not considered to be present.

Upon finding the obstacle 70 on the path using the sensor 19, the vehicle 10A notifies the presence of the obstacle 70 to the outside, e.g., the management device 50, via the second communication circuit 14d. For example, the vehicle 10A may notify to the management device 50 that the obstacle 70 is present between the markers M₁ and M₂. In the case where the vehicles 10A are able to measure the coordinates and the size of the obstacle 70 by using a laser range finder, information on the coordinates and the size of the obstacle 70 may be included in the notification.

Upon receiving the notification indicating the presence of the obstacle 70 from the vehicle 10A, the processing circuit 51 of the management device 50 indicates on the display 60 the presence of the obstacle 70, so as to be overlaid, etc., on the map of an area in which the vehicle 10A travels.

FIG. 2C shows a map displayed on the external display 60 of the management device 50, and also shows an icon 70a corresponding to the obstacle 70. Since the icon 70a is displayed, the operator of the management device 50 can easily recognize, from the map indication, where the obstacle is actually present.

The processing circuit 51 of the management device 50 specifies the two adjacent points (markers) M₁ and M₂ between which the obstacle 70 is located, and determines an avoidance path excluding the path connecting the specified two points.

FIG. 2D shows an example of an avoidance path of the vehicle 10A. In this example, the processing circuit 51 adds new markers Mₐ, M_{b}, M_{c} and M_{d} so that the avoidance path bypasses the obstacle 70 located on the line segments connecting the markers M₁ and M₂. Thus, the vehicle 10A can avoid collision with the obstacle 70.

Furthermore, the processing circuit 51 determines whether the path connecting the specified two markers is included in the traveling paths of the other vehicles 10. In the case where the path is included, the processing circuit 51 determines an avoidance path excluding the path connecting the specified two markers.

FIG. 2E illustrates an example of the avoidance path. In this example, the path of another vehicle 10B that follows behind the vehicle 10A is changed to a path that is slightly shifted so that the following vehicle will not collide with the obstacle 70. The processing circuit 51 of the management device 50 changes the markers M₁ and M₂ to markers M₁′ and M₂′ to attain this path change.

FIG. 2F illustrates another example of the avoidance path. In this example, the path of the other vehicle 10B that follows behind the vehicle 10A is changed altogether. The positions of the markers M₁ and M₂ are drastically changed to the markers M₁′ and M₂′.

Since the path is changed as described above, the vehicle 10A having detected the obstacle and the vehicle 10B following behind it can smoothly travel to their destination(s).

In another example, each vehicle 10 may autonomously avoid the obstacle 70. To achieve this, the controller 14a of the vehicle 10 may simply operate the vehicle 10 as follows.

(1) Ahead of the obstacle 70, e.g., several tens of centimeters ahead of the obstacle 70, the vehicle changes its traveling direction to the right by approximately 90 degrees, and advances by a distance nearly equal to the width of the obstacle 70. The width of the obstacle 70 may be measured using the sensor 19 or a laser range finder.

(2) The vehicle changes its traveling direction to the left by approximately 90 degrees and advances by a distance slightly longer than the length of the obstacle 70.

(3) The vehicle changes its traveling direction to the left by approximately 90 degrees and advances by a distance nearly equal to the width of the obstacle 70.

(4) The vehicle changes its traveling direction to the right by approximately 90 degrees and advances to the marker M₂.

The operations for avoiding the obstacle 70 by the vehicle 10A and/or 10B are not limited to the above examples, and any arbitrary algorithm may be applied.

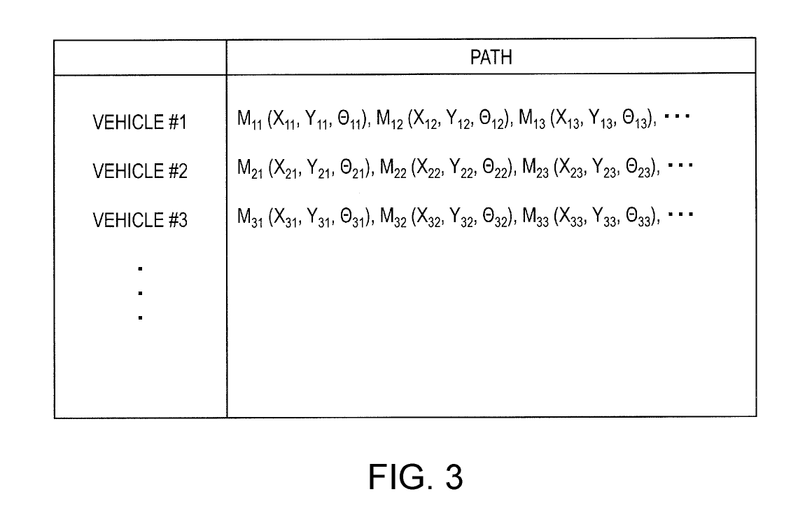

FIG. 3 illustrates an example of data indicating the traveling path of each vehicle 10 managed by the management device 50. This kind of data may be stored in a storage device (not shown in FIG. 1) provided in the management device 50. The data indicating the traveling path of each vehicle 10 may include information of a plurality of points (markers) on the path as shown in FIG. 3. The information of each marker may include information of the position (for example, the x coordinate and the y coordinate) of the marker and the direction (for example, the angle θ from the x-axis) of the vehicle 10 at the position. Although, in FIG. 3, the information of each marker is described as generalized signs, such as M₁₁ (x₁₁, y₁₁, θ₁₁), specific numerical values may be stored in actual applications.

The data of all markers may be transmitted to each vehicle 10 before the start of travel. As described above, as another example, the management device 50 may transmit the data of a next marker to each vehicle 10. In the latter application, the management device 50 receives the information of the present position of each vehicle 10 periodically, for example, every 100 msec, from each vehicle 10, thereby grasping the present position of each vehicle 10. Upon determining that there is a vehicle 10 that has reached the position of the designated marker, the management device 50 transmits the data of the next marker to that vehicle 10.

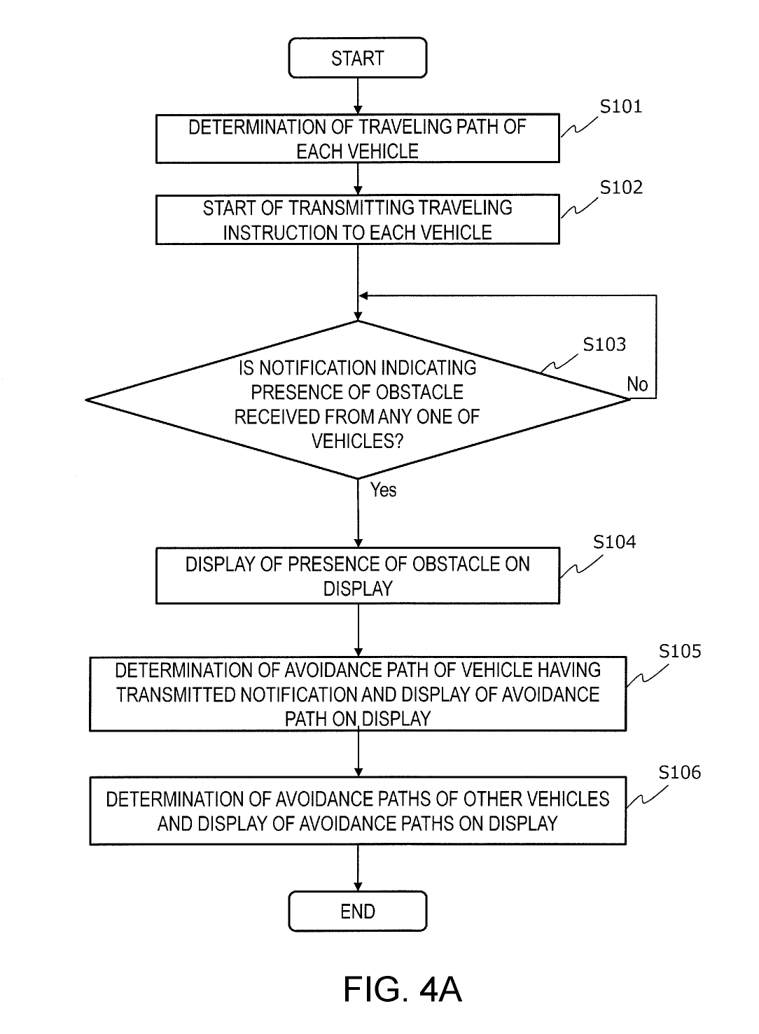

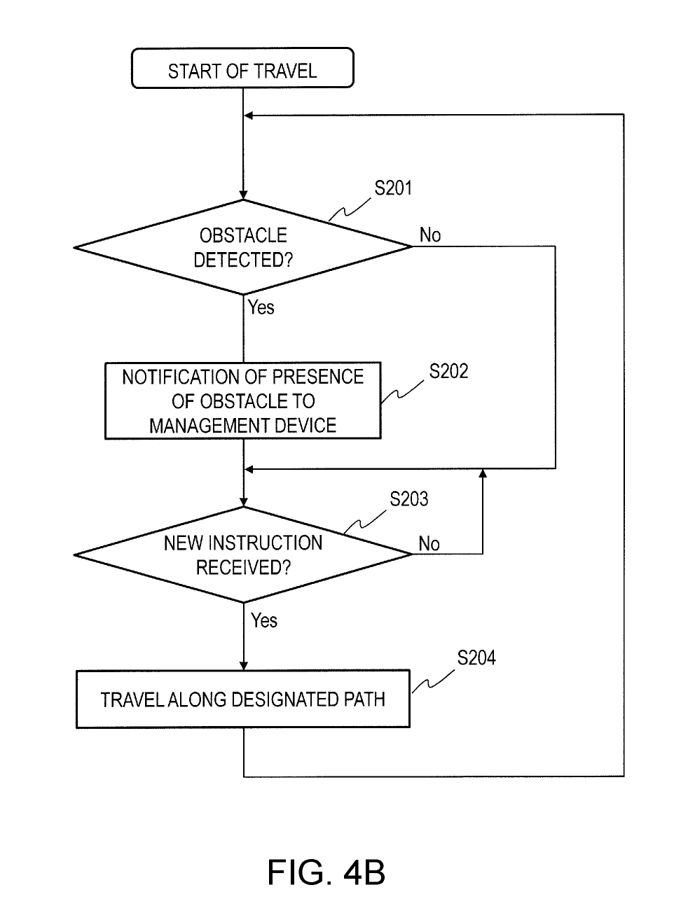

FIG. 4A is a flow chart showing an example operation of the processing circuit 51 of the management device 50. In this example, the processing circuit 51 performs the following operations.

At step S101, the processing circuit 51 determines the traveling path of each vehicle 10. The determination of the traveling path is performed in accordance with an instruction from the user or the administrator, or by a predetermined program.

At step S102, the processing circuit 51 starts transmitting a traveling instruction to each vehicle. The timing of the start of transmitting the traveling instruction to each vehicle is also determined in accordance with an instruction from the operator (i.e., the user or the administrator) or by a predetermined program.

At step S103, the processing circuit 51 determines whether a notification indicating the presence of an obstacle is received from any one of the vehicles 10. The process at step S103 continues until the determination says Yes. When the determination changes to Yes, the process advances to step S104.

At step S104, the processing circuit 51 indicates the presence of the obstacle on a display.

At step S105, the processing circuit 51 determines the avoidance path of the vehicle 10 having transmitted the notification and displays the avoidance path on the display. At this time, the processing circuit 51 specifies the two adjacent markers M₁ and M₂ between which the obstacle 70 is located and determines an avoidance path so as to avoid the traveling path between the markers M₁ and M₂.

At the next step S106, the processing circuit 51 determines the avoidance paths of the other vehicles 10 (i.e., any vehicle 10 other than the vehicle 10 having transmitted the notification), and displays the avoidance paths on the display. The vehicles 10 for which the avoidance paths are to be determined are the vehicles 10 having a traveling path between the above-mentioned markers M₁ and M₂. The processing circuit 51 may display only the avoidance paths of those vehicles 10 which were selected by the operator (i.e., the user or the administrator) on the display.

The display process by the processing circuit 51 is as described above. After that, to those vehicles 10 for which the avoidance paths have been determined, the data of the markers in accordance with the avoidance paths is transmitted.

Both the above-mentioned steps S105 and S106 do not always need to be performed. For example, only the step S105 may be performed.

FIG. 4B is a flow chart showing an example operation of the controller 14a of the vehicle 10. In this example, after the start of travel, the controller 14a performs the following operation.

At step S201, the controller 14a determines whether the obstacle sensor 19 has detected the obstacle 70. If the determination says Yes, the process advances to step S202. If determination says No, the process advances to step S203.

At step S202, the controller 14a notifies the presence of the obstacle 70 to the management device 50.

At step S203, the controller 14a determines whether a new instruction has been received from the management device 50. The “new instruction” is an instruction indicating markers specifying the avoidance path determined by the management device 50. If the determination says Yes, the process advances to step S204. If the determination says No, the determination of step S203 is repeated until a new instruction is received. In other words, since it is assumed that the previous traveling path cannot be maintained because of the presence of the obstacle 70, the vehicle 10 stands by where it is.

At step S204, the controller 14a causes the vehicles 10 to travel along the designated path.

The above-mentioned operation is an example and may be modified as appropriate.

In the case where the obstacle 70 is cargo, the cargo may be removed by being carried to another position. Thus, an example process where the vehicle 10 detects the obstacle 70 and notifies the presence of the obstacle 70 to the management device 50, but thereafter the obstacle 70 becomes removed will be described next.

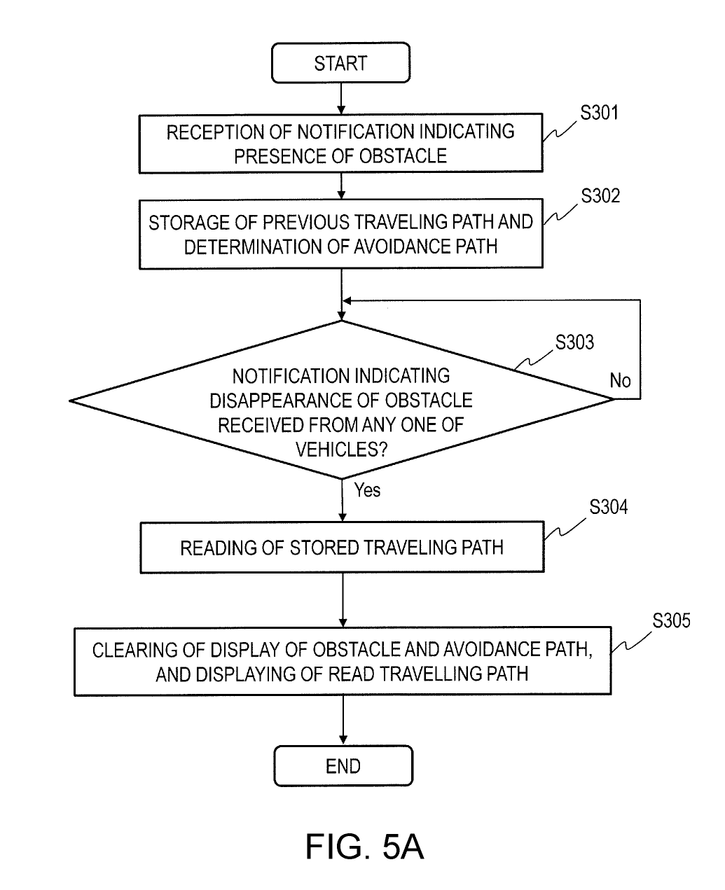

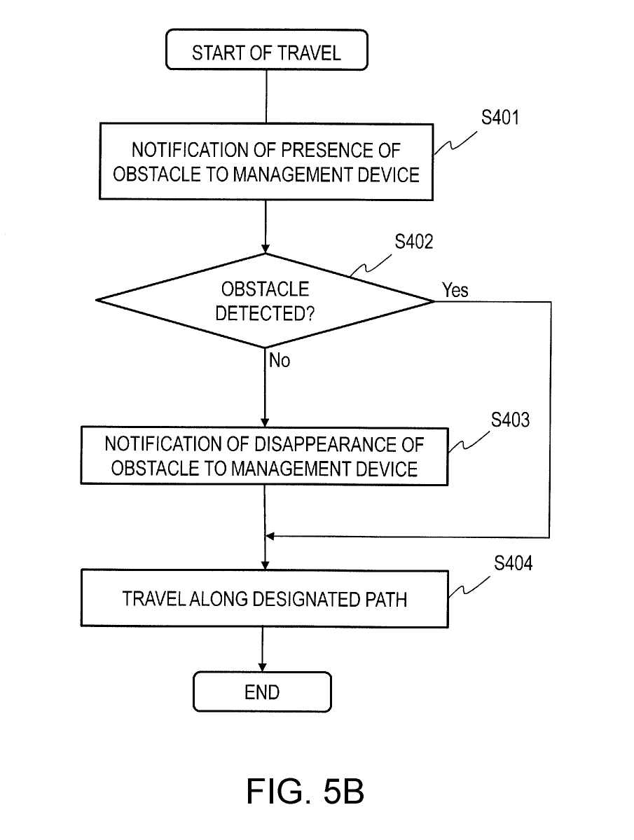

FIG. 5A is a flow chart showing an example operation of the processing circuit 51 of the management device 50 in the case where the obstacle disappears. In this example, the processing circuit 51 operates as described below.

First, at step S301, the processing circuit 51 receives a notification indicating that an obstacle is present. At step S302, the processing circuit 51 stores the previous traveling path in a storage device (not shown), and determines an avoidance path. The processing relating to reception of the notification and determination of the avoidance path is the sequence of processing shown in FIG. 4A.

At step S303, the processing circuit 51 determines whether the processing circuit 51 has received, from any one of the vehicles 10, a notification indicating that the obstacle has disappeared. The process at step S303 continues until such a notification is received. If the notification is not received, the processing circuit 51 continues to transmit an instruction urging the vehicle 10 to travel along the avoidance path determined at step S302.

At step S304, the processing circuit 51 reads the stored traveling path from the storage device. Next, at step S305, the processing circuit 51 clears the icon 70a indicating the obstacle 70 and the avoidance path, and instead displays the traveling path having been read.

At steps S304 and S305, the processing circuit 51 clears the avoidance path that has been determined once, and changes the traveling path back to its initial traveling path. These processes are performed because there is a possibility that, for example, the avoidance path may become complicated as in the example shown in FIG. 2D. Presumably, changing the traveling path back to the initial traveling path shown in FIG. 2A will attain an efficient travel. However, depending on the traveling position of the vehicle 10, changing the traveling path back to the initial traveling path may result in an inefficient way of travel. Therefore, for example, the processing circuit 51 may ascertain numerical values of some indexes, such as those indicating the travel distance to a certain marker (for example, the marker M₂ in FIG. 2A), the number of direction changes that may be required, and so on, and select a path that will result in those indexes having smaller numerical values.

After the traveling path having been read is displayed on the display, for example, with an approval of the operator, an instruction is transmitted to each vehicle 10 so that the vehicle will travel again along the initial traveling path.

FIG. 5B is a flow chart showing an example operation of the controller 14a of the vehicle 10 in the case where the obstacle has been detected but has disappeared afterwards. In this example, after the start of travel, the controller 14a operates as described below.

At step S401, the controller 14a notifies the presence of the obstacle 70 to the management device 50. Step S401 corresponds to the sequence of processing shown in FIG. 4B.

At step S402, the controller 14a determines whether the obstacle 70 has been detected. If the obstacle 70 has been detected, the process advances to step S404. On the other hand, if the obstacle is no longer detected, the process advances to step S403.

At step S403, the controller 14a notifies the disappearance of the obstacle 70 to the management device 50. In response to the notification, the processes at steps S304 and S305 shown in FIG. 5A are performed by the management device 50.

At step S404, the controller 14a controls the vehicle 10 so that the vehicle travels along the designated path. In the case where the process has advanced directly from step S402, the “designated path” at step S404 is the avoidance path; in the case where the process has advanced from step S403, the “designated path” at step S404 is the initial traveling path.

Some possible modifications to this embodiment will be described below.

Each vehicle 10 may further include a laser range finder, a storage device configured to store the environment map, and a localization device configured to determine the estimated values of the position and the direction of the vehicle 10 on the environment map and to output the estimated values. In this case, the controller 14a causes the vehicle to travel on the basis of the estimated values of the position and the direction output from the localization device and the signal indicating the traveling path transmitted from the processing circuit 51.

The processing circuit 51 may instruct each vehicle 10 to transmit the environment map or to update the environment map, according to the situation. For example, in the case where a signal indicating that an obstacle has been removed is not input within a certain period (for example, within several hours to several days) after a signal indicating the presence of the obstacle has been transmitted from any one of the plurality of the vehicles 10, the processing circuit 51 may instruct each vehicle 10 to update the environment map including the information on the obstacle.

A more specific example in the case where the vehicle is an automated guided vehicle will be described below. In the following descriptions, the automated guided vehicle is abbreviated to “AGV”. Furthermore, the following descriptions are similarly applicable to vehicles other than the AGV, such as a biped or multiped walking robot, a drone, a hovercraft or a manned vehicle, unless there is any contradiction.

(1) The Basic Construction of the System

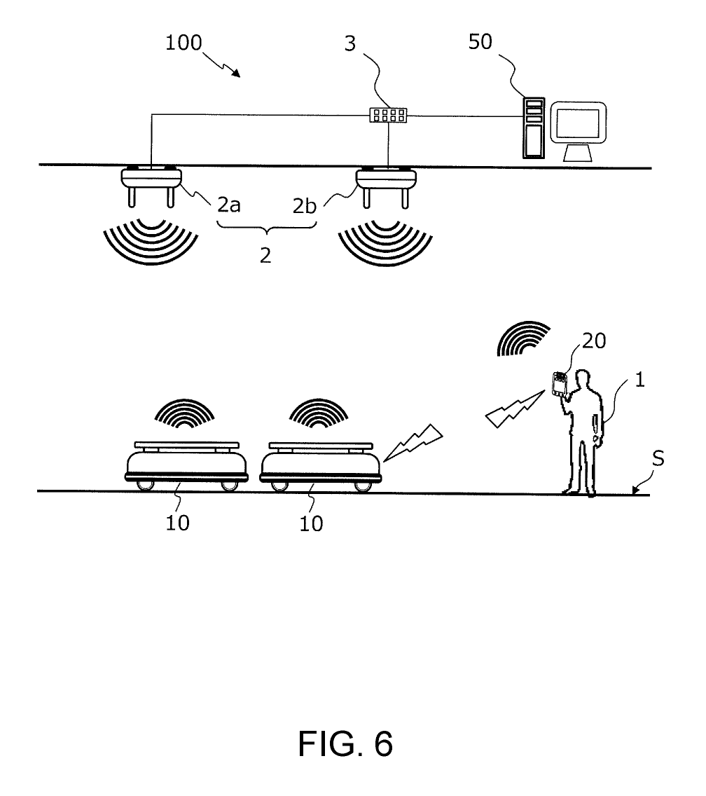

FIG. 6 shows an example of the basic construction of an exemplary vehicle management system 100 according to the present disclosure. The vehicle management system 100 includes at least one AGV 10 and a navigation management device 50 that manages navigation of the AGV 10. FIG. 6 also shows a terminal device 20 that is manipulated by a user 1.

The AGV 10 is an automated guided cart capable of performing “guideless” travel without requiring guiding signs, e.g., magnetic tapes, during travel. The AGV 10 can perform localization and can transmit the results of localization to the terminal device 20 and the navigation management device 50. The AGV 10 can perform automated travel in an area S according to instructions from the navigation management device 50.

The navigation management device 50 is a computer system that tracks the position of, and manages the travel of, each AGV 10. The navigation management device 50 may be a desk top PC, a laptop, and/or a server computer. The navigation management device 50 communicates with each AGV 10 via a plurality of access points 2. For example, the navigation management device 50 transmits, to each AGV 10, data of the coordinates of the position to which each AGV 10 is headed next. Each AGV 10 transmits data indicating the position and attitude (orientation) of itself to the navigation management device 50 periodically, for example, every 100 msec. When the AGV 10 reaches the designated position, the navigation management device 50 transmits data of the coordinates of the position to which the AGV 10 is headed further next. The AGV 10 can also travel in the area S according to a manipulation by the user 1 as input to the terminal device 20. An example of the terminal device 20 is a tablet computer. Typically, the travel of the AGV 10 using the terminal device 20 is performed at the time of map generation, and the travel of the AGV 10 using the navigation management device 50 is performed after the map generation.

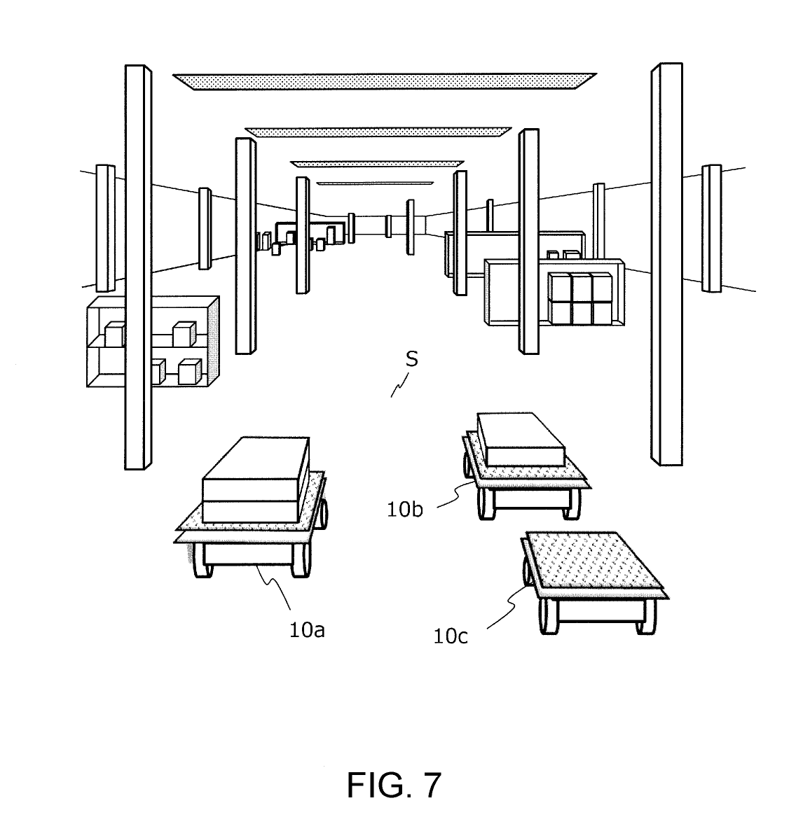

FIG. 7 shows an example of the area S in which three AGVs 10a, 10b and 10c are present. In this example, all AGVs are traveling in the depth direction in the figure. The AGVs 10a and 10b are each carrying cargo placed on the top board thereof. The AGV 10c is traveling so as to follow the AGV 10b that is traveling ahead. While reference numerals 10a, 10b and 10c are attached to the AGVs in FIG. 7 for convenience of explanation, each of these AGVs will be referred to as “the AGV 10” in the following description.

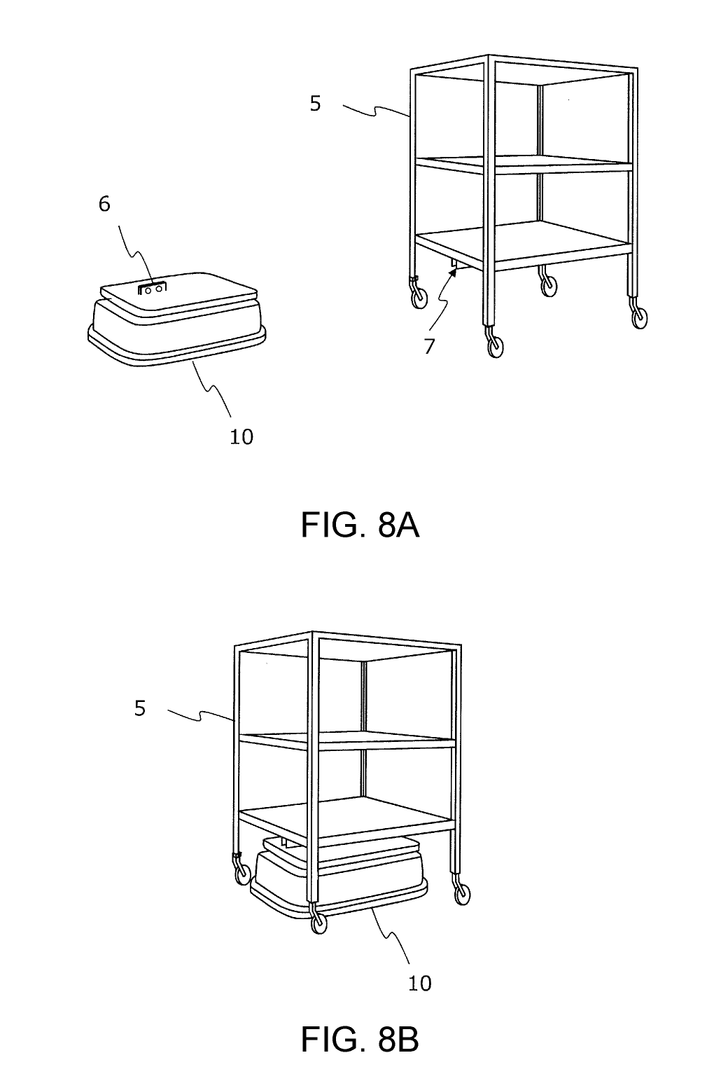

Other than by the method of carrying cargo placed on its top board, the AGV 10 may also carry cargo by using a trailer that is connected to itself. FIG. 8A shows the AGV 10 and a trailer 5 before being connected together. Each leg of the trailer 5 has a caster. The AGV 10 is mechanically connected to the trailer 5. FIG. 8B shows the AGV 10 and the trailer 5 having been connected together. When the AGV 10 travels, the trailer 5 is dragged by the AGV 10. The AGV 10 can carry the cargo placed on the trailer 5 by dragging the trailer 5.

The method of connecting the AGV 10 to the trailer 5 may be arbitrary; an example is described herein. A plate 6 is fixed to the top board of the AGV 10. The trailer 5 has a guide 7 with a slit. The AGV 10 approaches the trailer 5, and inserts the plate 6 into the slit of the guide 7. When the insertion is completed, the AGV 10 passes an electromagnetic locking pin (not shown) through the plate 6 and the guide 7, and engages electromagnetic locking. As a result, the AGV 10 and the trailer 5 are physically connected together.

FIG. 6 is referenced again. Each AGV 10 and the terminal device 20 may be connected e.g. in a one-to-one relationship to perform communications compliant with the Bluetooth standards (registered trademark) therebetween. Each AGV 10 and the terminal device 20 can also perform communications compliant with Wi-Fi (registered trademark) standards by using one or more access points 2. The plurality of access points 2 is mutually connected via, for example, a switching hub 3. Two access points 2a and 2b are shown in FIG. 6. The AGV 10 is wirelessly connected to the access point 2a. The terminal device 20 is wirelessly connected to the access point 2b. Any data transmitted by the AGV 10 is received by the access point 2a, transferred to the access point 2b via the switching hub 3, and transmitted from the access point 2b to the terminal device 20. Furthermore, any data transmitted by the terminal device 20 is received by the access point 2b, transferred to the access point 2a via the switching hub 3, and transmitted from the access point 2a to the AGV 10. Thus, bidirectional communications are achieved between the AGV 10 and the terminal device 20. The plurality of access points are also connected to the navigation management device 50 via the switching hub 3. Consequently, bidirectional communications are also achieved between the navigation management device 50 and each AGV 10.

(2) Environment Map Generation

A map in the area S is generated in order to allow the AGV 10 to travel while estimating its own position. The AGV 10 includes a localization device and a laser range finder. The AGV 10 can generate a map by using the output of the laser range finder.

The AGV 10 can transition to a data acquisition mode in response to the user's manipulation. In the data acquisition mode, the AGV 10 starts acquisition of sensor data by using the laser range finder. The laser range finder periodically scans the area S by emitting, for example, an infrared or visible light laser beam, around itself. The laser beam is reflected, for example, by the surface of a structure, such as a wall or a pillar, or the surface of an object placed on the floor. The laser range finder receives the reflected light of the laser beam, calculates a distance to each reflection point, and outputs data of the measurement results indicating the position of each reflection point. The position of each reflection point reflects the direction of the arrival and the distance of the reflected light. The data of measurement results may be referred to as “measurement data” or “sensor data” in some cases.

The localization device stores the sensor data in a storage device. When the acquisition of the sensor data in the area S is completed, the sensor data stored in the storage device is transmitted to an external device. The external device may be, for example, a computer which has a signal processor and in which a map generation program is installed.

The signal processor of the external device allows the sensor data acquired in respective scanning operations to be overlaid upon one another. The signal processor repeatedly performs the overlaying processing, whereby the map of the area S can be generated. The external device transmits the generated map data to the AGV 10. The AGV 10 stores the generated map data in its internal storage device. The external device may be the navigation management device 50, or may be another device.

Instead of an external device, the AGV 10 may itself generate the map. Instead of the signal processor of the above-mentioned external device, a circuit, such as the microcontroller unit (MCU) in the AGV 10, may perform the above processing. In the case where the AGV 10 generates the map, the stored sensor data does not need to be transmitted to the external device. It is generally assumed that the sensor data is large in data volume. Absence of a need to transmit sensor data to the external device can prevent communication lines from becoming occupied.

The movement inside the area S which is performed in order to acquire the sensor data can be attained by causing the AGV 10 to travel according to the user's manipulation. For example, the AGV 10 wirelessly receives traveling instructions indicating respective movements in the front/rear/right/left directions from the user, via the terminal device 20. According to the traveling instructions, the AGV 10 travels in the right-left and front-rear directions inside the area S, thereby generating the map. In the case where the AGV 10 is connected by wire to a control terminal, such as a joystick, the AGV 10 may follow the control signals from the control terminal in traveling in the front/rear/right/left directions inside the area S, thereby generating the map. It may also be possible for the sensor data to be acquired by a person who pushes along a measurement cart having a laser range finder, while walking.

Although a plurality of AGVs 10 are illustrated in FIGS. 1 and 2, there may only be one AGV 10. In the case where a plurality of AGVs 10 are present, the user 1 may use the terminal device 20 to select one of the plurality of registered AGVs 10, and allow the selected AGV 10 to generate the map of the area S.

After the map is generated, each AGV 10 can perform automated travel while estimating its own position by using the map. The processing for estimating the AGV's own position will be described later.

(3) Configuration of the AGV

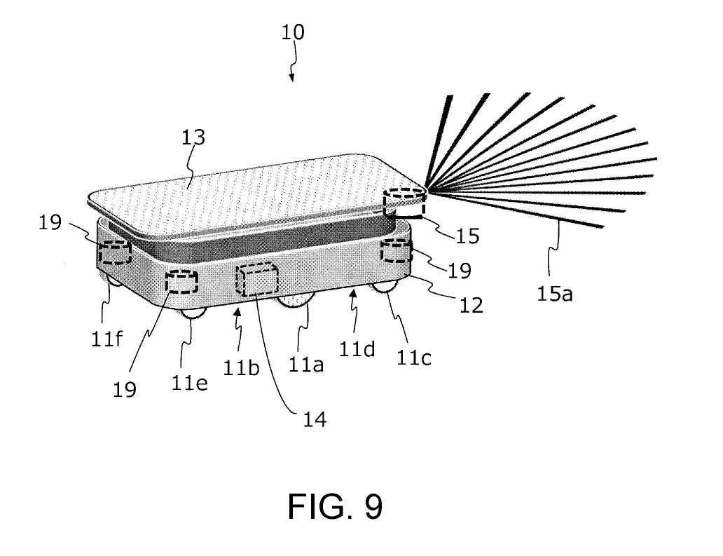

FIG. 9 is a view showing an external appearance of an exemplary AGV 10 according to the present embodiment.

The AGV 10 includes two drive wheels 11a and 11b, four casters 11c, 11d, 11e and 11f, a frame 12, a carrying table 13, a travel control device 14 and a laser range finder 15. The two drive wheels 11a and 11b are provided on the right side and the left side of the AGV 10, respectively. The four casters 11c, 11d, 11e and 11f are disposed at the four corners of the AGV 10. The AGV 10 also has a plurality of motors connected to the two drive wheels 11a and 11b, although the motors are not shown in FIG. 9. FIG. 9 shows the drive wheel 11a and the two casters 11c and 11e positioned on the right side of the AGV 10, and the caster 11f positioned at the left rear portion of the AGV 10. The left drive wheel 11b on the left side and the caster 11d at the left front portion are not shown clearly in FIG. 9 because they are obscured behind the frame 12. The four casters 11c, 11d, 11e and 11f can swivel freely. In the following description, the drive wheel 11a and the drive wheel 11b may also be referred to as the wheel 11a and the wheel 11b, respectively.

The AGV 10 further includes at least one obstacle sensor 19 to detect obstacles. In the example shown in FIG. 9, four obstacle sensors 19 are provided at the four corners of the frame 12, respectively. The number and arrangement of the obstacle sensors 19 may be different from those in the example shown in FIG. 9. The obstacle sensor 19 may be a device capable of performing ranging, such as an infrared sensor, an ultrasonic sensor, or a stereo camera. In the case where the obstacle sensor 19 is an infrared sensor, the sensor can detect an obstacle that is present within a certain distance by emitting infrared rays, for example, at every certain period of time, and by measuring the time until the infrared rays reflected by the obstacle are returned. When an obstacle on a path is detected on the basis of a signal output from at least one of the obstacle sensors 19, the AGV 10 may perform an operation of avoiding the obstacle.

The travel control device 14 is a device for controlling the operation of the AGV 10. The travel control device 14 mainly includes integrated circuits including an MCU (described later), electronic parts, and a circuit board on which these integrated circuits and electronic parts are mounted. The travel control device 14 performs data transmission/reception with the above-mentioned terminal device 20 and also performs preprocessing operations.

The laser range finder 15 is an optical instrument that emits, for example, an infrared or visible light laser beam 15a, and detects reflected light of the laser beam 15a to measure a distance to the reflection point. In this embodiment, the laser range finder 15 of the AGV 10 emits a pulsed laser beam 15a in an area spanning an angle range of 135 degrees to the right and left (for a total of 270 degrees) of e.g. the front face of the AGV 10, while changing the direction of the laser beam 15a by every 0.25 degrees, and detects the reflected light of the laser beam 15a. This provides data of distance to the reflection point in directions determined by a total of 1081 steps of angle in every 0.25 degrees. In this embodiment, the scanning performed by the laser range finder 15 in the area therearound is performed substantially in parallel with the floor surface, that is, in a planar (two-dimensional) manner. Instead, the laser range finder 15 may perform scanning in the height direction.

From the position and attitude (orientation) of the AGV 10 and the scanning results of the laser range finder 15, the AGV 10 can generate a map of the area S. The structures, such as the walls and pillars, and the arrangement of the objects placed on the floor around the AGV 10 may be incorporated into the map. The data of the map is stored to the storage device in the AGV 10.

Generally speaking, the position and attitude of a vehicle are referred to as a pose. The position and attitude of a vehicle in a two-dimensional plane may be represented by position coordinates (x, y) in an XY Cartesian coordinate system and an angle θ with respect to the X-axis. The position and the attitude, i.e., pose (x, y, θ), of the AGV 10 may be simply referred to as “position” in the following description.

The position of a reflection point as viewed from the position at which the laser beam 15a is emitted can be expressed by using polar coordinates that are defined in terms of angle and distance. In this embodiment, the laser range finder 15 outputs sensor data that is expressed in polar coordinates. However, the laser range finder 15 may convert a position that is expressed in polar coordinates into a position expressed in Cartesian coordinates, and may output the converted position data.

Since the structure and operation principles a laser range finder are well-known, any more detailed description thereof will be omitted in the present specification. Examples of objects that can be detected by the laser range finder 15 include humans, cargo, shelves, and walls.

The laser range finder 15 is an example of an external sensor that acquires sensor data by sensing the area therearound. Other examples of such external sensors include image sensors and ultrasonic sensors.

The travel control device 14 can estimate the current position of the device itself by comparing the measurement results of the laser range finder 15 with the map data stored in itself. The map data stored in the device may have been generated by another AGV 10.

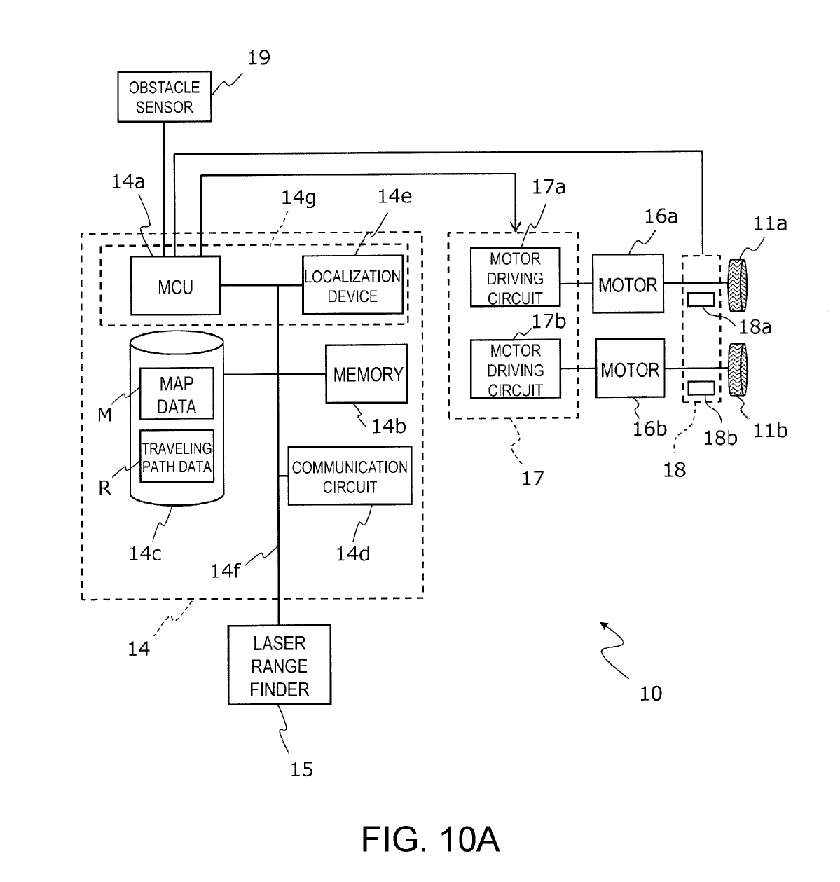

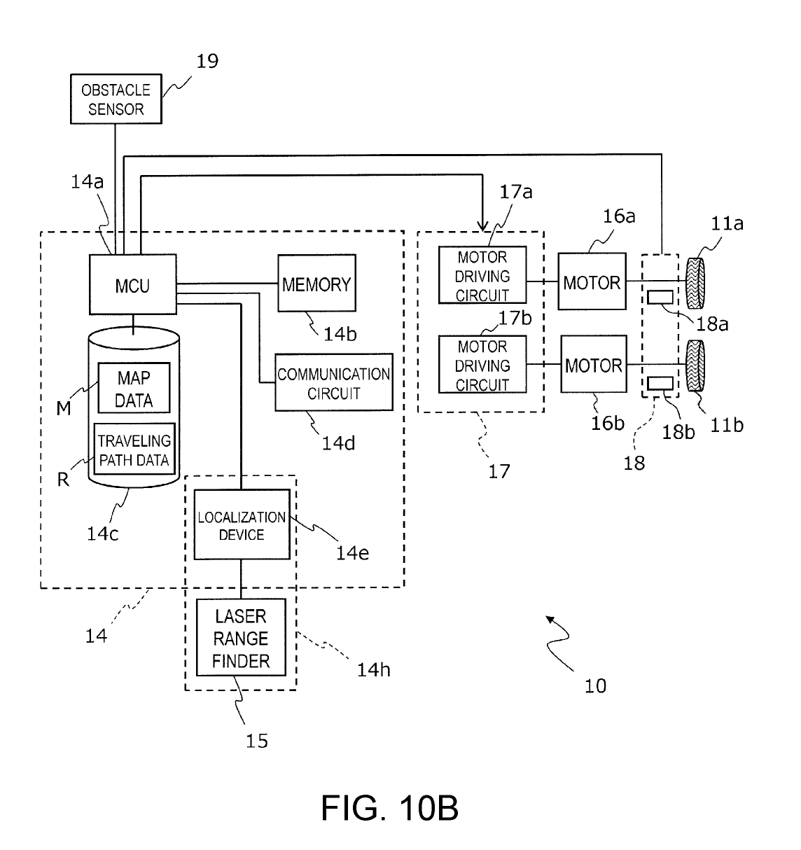

FIG. 10A shows a first example of the hardware construction of the AGV 10. FIG. 10A also shows a specific construction of the travel control device 14.

The AGV 10 includes the travel control device 14, the laser range finder 15, two motors 16a and 16b, a driving device 17, the wheels 11a and 11b, and two rotary encoders 18a and 18b.

The travel control device 14 includes an MCU 14a, a memory 14b, a storage device 14c, a communication circuit 14d, and a localization device 14e. The MCU 14a, the memory 14b, the storage device 14c, the communication circuit 14d, and the localization device 14e are connected via a communication bus 14f, so as to be capable of exchanging data with one another. The laser range finder 15 is also connected to the communication bus 14f via a communication interface (not shown). The laser range finder 15 transmits measurement data, that is, measurement results, to the MCU 14a, the localization device 14e and/or the memory 14b.

The MCU 14a is a processor or a control circuit that performs computation for controlling the entire AGV 10 including the travel control device 14. The MCU 14a is typically a semiconductor integrated circuit. The MCU 14a transmits a PWM (Pulse Width Modulation) signal serving as a control signal to the driving device 17, thereby controlling the driving device 17 and regulating the voltages to be applied to the motors. As a result, each of the motors 16a and 16b is rotated at a desired rotational speed.

One or more control circuits for controlling the driving of the left and right motors 16a and 16b may be provided independently of the MCU 14a. For example, the motor driving device 17 may be equipped with two MCUs for respectively controlling the motors 16a and 16b. The two MCUs may respectively perform coordinate calculations using the encoder information which is output from the encoders 18a and 18b, thereby estimating a traveled distance of the AGV 10 from a predetermined initial position. Furthermore, the two MCUs may control motor driving circuits 17a and 17b by using the encoder information.

The memory 14b is a volatile storage device for storing a computer program to be executed by the MCU 14a. The memory 14b can also be used as a work memory when the MCU 14a and the localization device 14e perform computations.

The storage device 14c is a nonvolatile semiconductor memory device. Alternatively, the storage device 14c may be a magnetic storage medium such as a hard disk, or an optical storage medium such as an optical disc. The storage device 14c may include a head device for writing and/or reading data on and/or from either one of the storage media, and a controller for the head device.

The storage device 14c stores map data M of the area S in which the AGV 10 travels and data R of one or more traveling paths. The map data M may be generated by the AGV 10 operating in a map generation mode, and stored in the storage device 14c. After the map data M is generated, the traveling path data R may be transmitted from the outside. Although this embodiment illustrates that the map data M and the traveling path data R are stored in the same storage device, i.e., the storage device 14c, the data may be stored in different storage devices.

An example of the traveling path data R will be described below.

If the terminal device 20 is a tablet computer, the AGV 10 may receive the traveling path data R, which indicates a traveling path, from the tablet computer. The traveling path data R may include marker data indicating the positions of a plurality of markers. The “markers” indicate the positions (“passing points”) that are passed by the traveling AGV 10. The traveling path data R includes at least the position information of a start marker indicating a traveling start position and an end marker indicating a traveling end position. The traveling path data R may further include the position information of markers at one or more intermediate passing points. If the traveling path includes one or more intermediate passing points, the path which spans from the start marker to the end marker while sequentially passing through the passing points is defined as a traveling path. The data of each marker may include not only coordinate data of the marker but also data of the orientation (or angle) and the travelling speed of the AGV 10 until the AGV 10 reaches to the next marker. The AGV 10 may temporarily stop at the position of each marker, perform localization, and give a notification to the terminal device 20; in this case the data of each marker may include data of the acceleration time required until reaching the traveling speed and/or data of the deceleration time required until the vehicle traveling at that traveling speed stops at the position of the next marker.

Instead of the terminal device 20, the navigation management device 50 (e.g., a PC or a server computer) may control the movement of the AGV 10. In that case, each time the AGV 10 reaches a marker, the navigation management device 50 may instruct the AGV 10 to move to the next marker. For example, the AGV 10 receives coordinate data of the next destination position, or data of the distance and the angle to proceed to the destination position, as the traveling path data R indicating the traveling path.

The AGV 10 may travel along the stored traveling path while estimating its own position using the generated map and the sensor data acquired during travel from the laser range finder 15.

The communication circuit 14d may be a wireless communication circuit configured to perform wireless communications compliant with, for example, the Bluetooth (registered trademark) standards and/or the Wi-Fi (registered trademark) standards. Either of such standards includes wireless communication standards in which a 2.4 GHz frequency band is used. For example, under the mode in which the AGV 10 is made to travel in order to generate a map, the communication circuit 14d performs wireless communications compliant with the Bluetooth standards and performs one-to-one communications with the terminal device 20.

The localization device 14e performs map generation processing, and localization processing during travel. The localization device 14e generates a map of the area S on the basis of the position and attitude of the AGV 10 and the scanning results of the laser range finder 15. While the vehicle is traveling, the localization device 14e receives the sensor data from the laser range finder 15 and reads the map data M stored in the storage device 14c. The localization device 14e identifies the AGV's position (x, y, θ) on the map data M by matching the local map data (or sensor data) generated from the scanning results of the laser range finder 15 against wider-range map data M. The localization device 14e generates “reliability” data indicating the degree of coincidence of the local map data with the map data M. The respective data of the AGV's position (x, y, θ) and reliability can be transmitted from the AGV 10 to the terminal device 20 or the navigation management device 50. The terminal device 20 or the navigation management device 50 may receive the respective data of the AGV's position (x, y, θ) and the reliability and may display the data on a display that is built therein or connected thereto.

Although the MCU 14a and the localization device 14e are illustrated as separate components in this embodiment, this is just an example. It may be possible to use a single chip circuit or a single semiconductor integrated circuit in which the operation of the MCU 14a and the operation of the localization device 14e can be performed independently. FIG. 10A shows a chip circuit 14g including the MCU 14a and the localization device 14e. In the following description, an example in which the MCU 14a and the localization device 14e are provided separately and independently of each other will be described.

The two motors 16a and 16b are attached to the two wheels 11a and 11b, respectively, in order to rotate the respective wheels. In other words, the two wheels 11a and 11b are both drive wheels. In this embodiment, the motors 16a and 16b drive the right wheel and the left wheel of the AGV 10, respectively.

The AGV 10 further includes an encoder unit 18 for measuring rotation positions and rotational speeds of the wheels 11a and 11b. The encoder unit 18 includes the first rotary encoder 18a and the second rotary encoder 18b. The first rotary encoder 18a measures rotation at a position in the power transmission mechanism spanning from the motor 16a to the wheel 11a. The second rotary encoder 18b measures rotation at a position in the power transmission mechanism spanning from the motor 16b to the wheel 11b. The encoder unit 18 transmits the signals acquired by the rotary encoders 18a and 18b to the MCU 14a. The MCU 14a may control the movement of the AGV 10 by using not only the signal received from the localization device 14e but also the signal received from the encoder unit 18.

The driving device 17 has motor driving circuits 17a and 17b for regulating the voltages to be applied to the two motors 16a and 16b, respectively. Each of the motor driving circuits 17a and 17b may include an inverter circuit. The motor driving circuits 17a and 17b may turn ON or OFF the currents flowing in the respective motors in response to PWM signals transmitted from the MCU 14a or the MCU in the motor driving circuit 17a, thereby regulating the voltages to be applied to the motors.

FIG. 10B shows a second example of the hardware construction of the AGV 10. The second example hardware construction differs from the first example hardware construction (FIG. 10A) in that a laser positioning system 14h is provided and that the MCU 14a and each of the other components are connected in a one-to-one relationship.

The laser positioning system 14h includes the localization device 14e and the laser range finder 15. The localization device 14e and the laser range finder 15 are connected together via, for example, an Ethernet (registered trademark) cable. The operations of the localization device 14e and the laser range finder 15 are as described above. The laser positioning system 14h outputs information indicating the pose (x, y, θ) of the AGV 10 to the MCU 14a.

The MCU 14a has various general-purpose I/O interfaces or general-purpose input/output ports (not shown). The MCU 14a is directly connected to other components inside the travel control device 14, such as the communication circuit 14d and the laser positioning system 14h, via the general-purpose input/output ports.

The construction other than those described above with respect to FIG. 10B is identical to the construction shown in FIG. 10A. Hence, the description of any such common construction is omitted.

The AGV 10 according to an embodiment of the present disclosure may include a safety sensor, such as a bumper switch (not shown). The AGV 10 may also include an inertial measurement device, such as a gyro sensor. The traveled distance and the change amount (or angle) of the attitude of the AGV 10 may be estimated by using measurement data obtained by internal sensors, such as the rotary encoders 18a and 18b or the inertial measurement device. Such estimated values of distance and angle are referred to as odometry data or odometry information. Odometry data may serve to compliment the position and attitude data obtained by the localization device 14e. The odometry data may be used when the reliability of the estimated values of the position and attitude obtained by the localization device 14e is low, or when a map switching operation is performed.

(4) Map Data

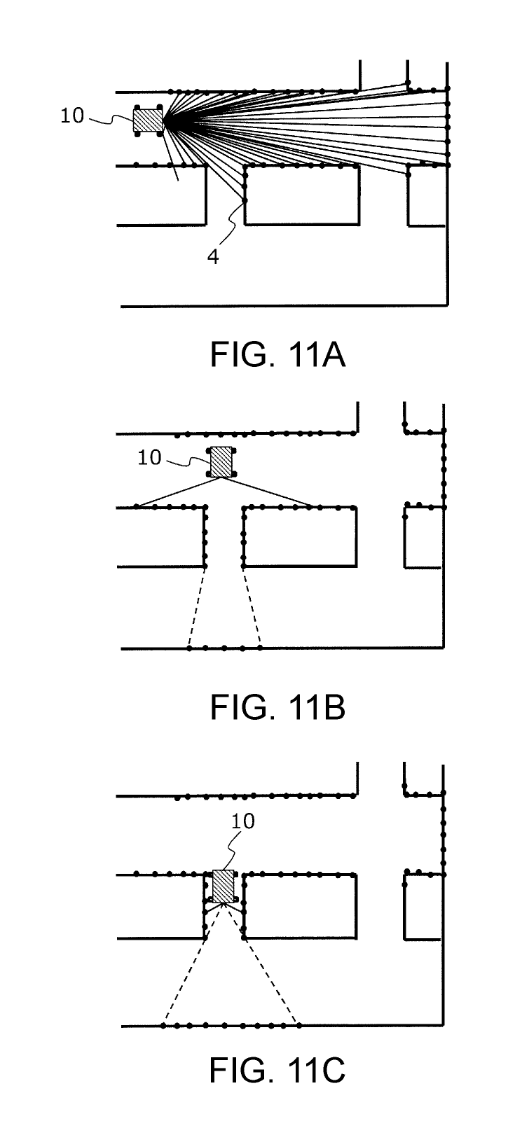

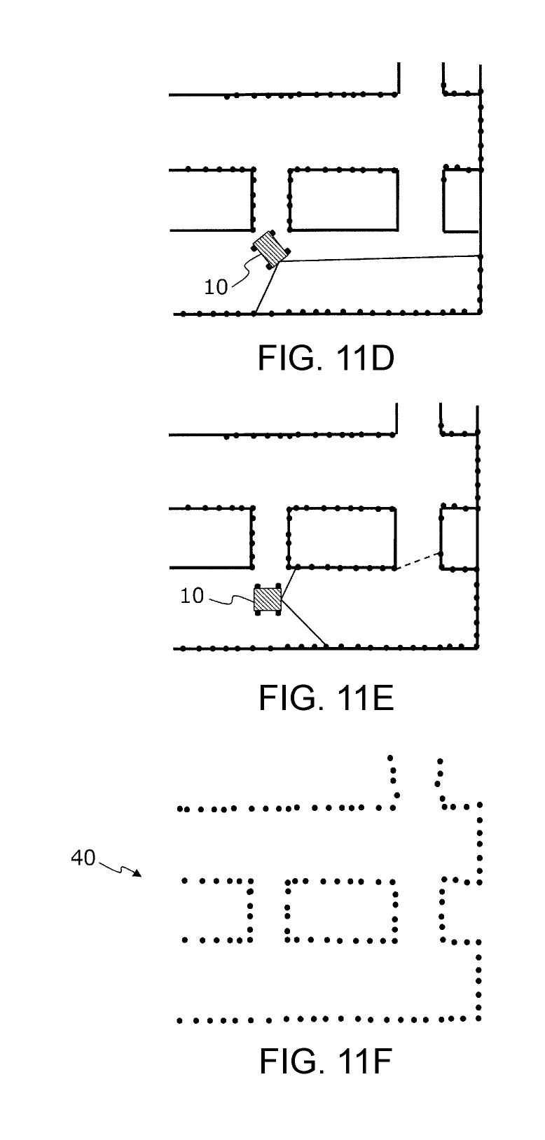

FIGS. 11A to 11F schematically illustrate the AGV 10 moving while acquiring sensor data. The user 1 may manually move the AGV 10 by manipulating the terminal device 20. Alternatively, the sensor data may be acquired by placing a unit having the travel control device 14 shown in FIGS. 10A and 10B, or the AGV 10 itself, onto a cart, and by pushing or pulling the cart with the hand of the user 1.

FIG. 11A illustrates the AGV 10 scanning the area around the vehicle using the laser range finder 15. A laser beam is emitted at every predetermined step angle, and scanning is performed. The scanning range shown in the figure is only a schematic example, which differs from the above-mentioned total scanning range of 270 degrees.

In each of FIGS. 11A to 11F, positions of the reflection points of the laser beam are shown schematically with a plurality of black points 4, each represented by a sign “⋅”. Laser beam scanning is performed in a short cycle while the position and attitude of the laser range finder 15 are being changed. Therefore, the number of actual reflection points is far greater than the number of reflection points 4 shown in the figures. The localization device 14e stores data of the positions of the black points 4 obtained by the travel to e.g. the memory 14b. As scanning is continuously performed while the AGV 10 is traveling, map data is gradually completed. For simplicity, FIGS. 11B to 11E only depict the scanning ranges. The scanning ranges shown are also exemplary, and differ from the above-mentioned example of 270 degrees in total.

The MCU 14a in the AGV 10 or an external computer may obtain a necessary amount of sensor data for map generation, and then generate a map based on the sensor data. Alternatively, the traveling AGV 10 may generate a map in real time, on the basis of the acquired sensor data.

FIG. 11F schematically shows a part of a completed map 80. In the map shown in FIG. 11F, free space is partitioned by point clouds corresponding to groups of reflection points of the laser beam. Another example of a map may be an occupancy grid map in which the area occupied by an object is distinguished, in grid units, from the rest of free space. The localization device 14e stores data of the map (i.e., the map data M) to the memory 14b or the storage device 14c. The number or density of black points illustrated in the figure is only an example.

The map data obtained as described above may be shared among a plurality of AGVs 10.

A typical example of an algorithm for the AGV 10 to estimate its own position on the basis of map data is ICP (Iterative Closest Point) matching. As described above, the AGV's position (x, y, θ) on the map data M may be estimated by matching the local map data (sensor data) generated from the scanning results of the laser range finder 15 against wider-range map data M.

If the area in which the AGV 10 travels is wide, the amount of the map data M will be large. This may cause inconveniences, e.g., map generation time may increase or a large amount of time may be required for localization. To avoid such inconveniences, the map data M may be generated and recorded in a manner of being divided into a plurality of partial map data segments.

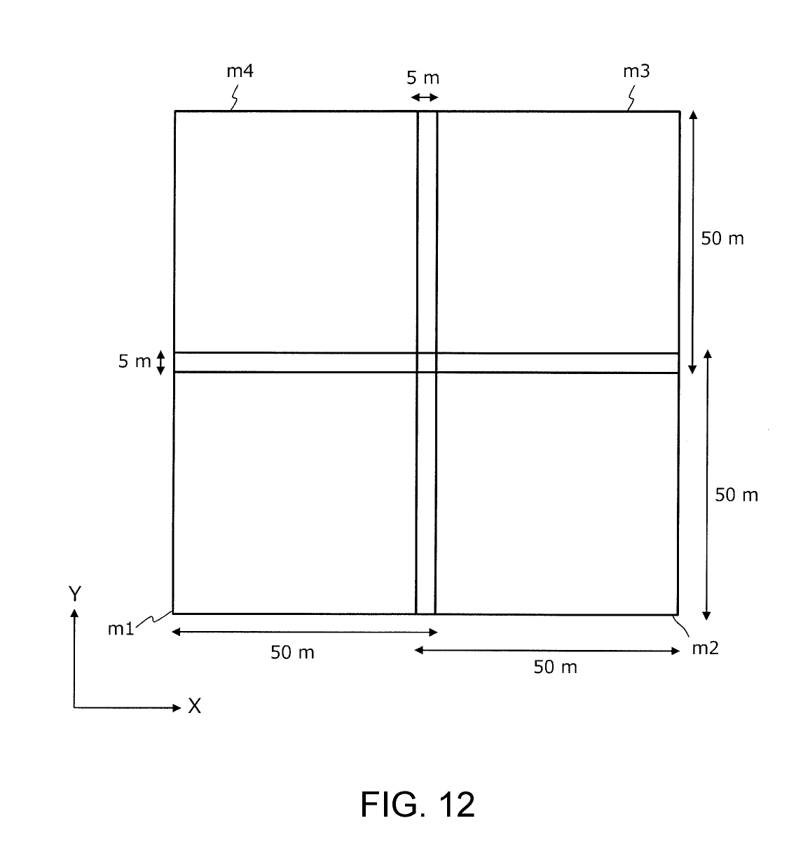

FIG. 12 shows an example in which one floor of a factory is entirely covered by a combination of four partial map data segments m1, m2, m3 and m4. In this example, one partial map data segment covers an area of 50 m×50 m. At each boundary between two adjacent partial map data segments along the X-direction or the Y-direction, a rectangular overlapping area having a width of 5 m is provided. This overlapping area is referred to as a “map switching area”. Once the AGV 10 that travels while referring to one partial map segment reaches a map switching area, the traveling mode of the vehicle is switched to a different mode in which the vehicle refers to another, adjacent partial map data segment. The number of partial map data segments is not limited to four, and the number may be set in accordance with the geometric area of the floor which is traveled by the AGV 10 and the performance of the computer that carries out map generation and localization. The size of each partial map data segment and the width of each overlapping area are not limited to the above-mentioned examples, but may be set arbitrarily.

(5) An Example Construction of the Navigation Management Device

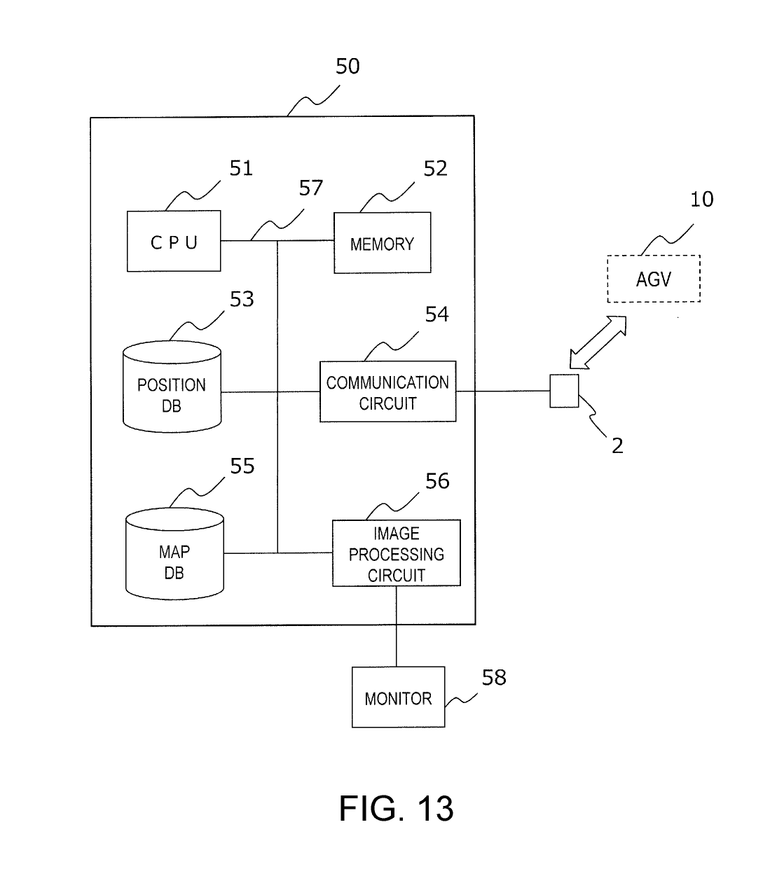

FIG. 13 shows an example hardware construction of the navigation management device 50. The navigation management device 50 includes a CPU 51, a memory 52, a position database (position DB) 53, a communication circuit 54, a map database (map DB) 55, and an image processing circuit 56.

The CPU 51, the memory 52, the position DB 53, the communication circuit 54, the map DB 55, and the image processing circuit 56 are connected via a communication bus 57, so as to be capable of exchanging data with one another.

The CPU 51 is a signal processing circuit (or a computer) configured to control the operation of the navigation management device 50. The CPU 51 is typically a semiconductor integrated circuit.

The memory 52 is a volatile storage device that stores a computer program to be executed by the CPU 51. The memory 52 may also be used as a work memory when the CPU 51 performs computations.

The position DB 53 stores position data indicating respective positions that may become the destinations of the respective AGVs 10. The position data may be represented by coordinates that are virtually designated inside a factory by an administrator. The position data may be determined by the administrator.

The communication circuit 54 performs wired communications compliant with, for example, the Ethernet (registered trademark) standards. The communication circuit 54 is connected to the access points 2 (see FIG. 6) by wire and can communicate with the AGV 10 via the access points 2. Via the bus 57, the communication circuit 54 may receive data to be transmitted to the AGV 10 from the CPU 51. The communication circuit 54 may also transmit data (or notification) that is received from the AGV 10 to the CPU 51 and/or the memory 52, via the bus 57.

The map DB 55 stores data of the map of a factory or warehouse, etc. in which the AGV 10 travels. The map may be identical to the map 80 (shown in FIG. 11F), or may be different from the map 80. The format of the map data does not matter so long as the map has one-to-one correspondence with respect to the positions of the respective AGVs 10. For example, the map to be stored in the map DB 55 may have been generated by CAD (Computer-Aided Design).

The position DB 53 and the map DB 55 may be stored on a nonvolatile semiconductor memory. Alternatively, these DBs may be stored on a magnetic storage medium such as a hard disk or on an optical storage medium such as an optical disc.

The image processing circuit 56 is configured to generate image data to be displayed on a monitor 58. The image processing circuit 56 operates when the administrator manipulates the navigation management device 50. Any more detailed description thereof will be omitted for the purpose of this embodiment. The monitor 58 may be integrated with the navigation management device 50. The processing by the image processing circuit 56 may be performed by the CPU 51 instead.

(6) Operation of the Navigation Management Device

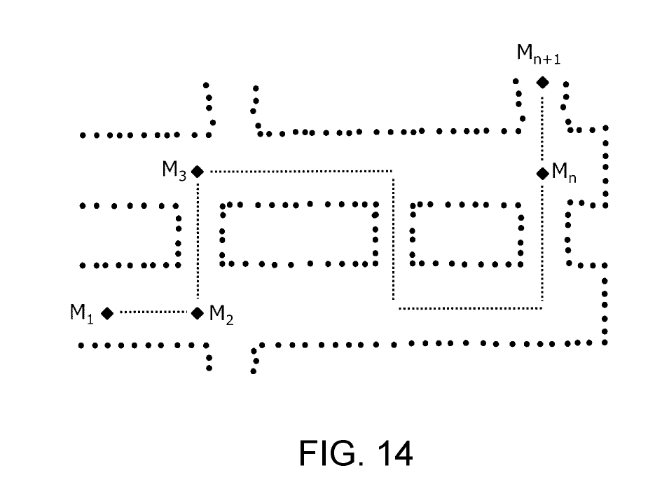

An outline of the operation of the navigation management device 50 will be described with reference to FIG. 14. FIG. 14 is a schematic view showing an exemplary traveling path for the AGV 10 that is determined by the navigation management device 50.

The operations of the AGV 10 and the navigation management device 50 will be described in outline below. In the following description, an example is described in which an AGV 10 that is currently located at a point (marker) M₁ passes several positions, and travels to a marker Mₙ₊₁ (n: a positive integer of 1 or more), i.e., the final destination. The position DB 53 stores coordinate data indicating respective positions, such as a marker M₂ to be passed next to the marker M₁ and a marker M₃ to be passed next to the marker M₂, etc.

The CPU 51 in the navigation management device 50 reads the coordinate data of the marker M₂ by referring to the position DB and generates a traveling instruction for moving the AGV 10 toward the marker M₂. The communication circuit 54 transmits the traveling instruction to the AGV 10 via the access points 2.

From the AGV 10, the CPU 51 periodically receives data indicating the current position and attitude of the AGV 10, via the access points 2. Thus, the navigation management device 50 can track the position of each AGV 10. Upon determining that the present position of the AGV 10 has matched the marker M₂, the CPU 51 reads the coordinate data of the marker M₃, generates a traveling instruction for moving the AGV 10 toward the marker M₃, and transmits the traveling instruction to the AGV 10. In other words, upon determining that the AGV 10 has reached a certain position, the navigation management device 50 transmits a traveling instruction for moving the AGV 10 toward the position to be passed next. As a result of this, the AGV 10 can reach the marker Mₙ₊₁, i.e., the final destination.

The above-mentioned operations are taken as examples, and the operations in the above-mentioned plurality of examples can be combined appropriately. The above-mentioned respective operations can be performed by executing the computer program stored in the non-transitory storage medium using an integrated circuit, such as a CPU.

The present disclosure may also be attained by a system, a method, an integrated circuit, a computer program or a storage medium. Alternatively, the embodiment may also be attained by arbitrarily combining a system, a device, a method, an integrated circuit, a computer program and a storage medium.

The vehicle and the vehicle management system according to the present disclosure can be preferably used for moving and carrying goods, parts, finished products, etc. in factories, warehouses, construction sites, physical distribution bases, hospitals, etc.

While the present disclosure has been described with respect to exemplary embodiments thereof, it will be apparent to those skilled in the art that the disclosed disclosure may be modified in numerous ways and may assume many embodiments other than those specifically described above. Accordingly, it is intended by the appended claims to cover all modifications of the disclosure that fall within the true spirit and scope of the disclosure.

What is claimed is:

1. A vehicle capable of moving autonomously, the vehicle comprising:
a communication circuit;
an obstacle sensor, configured to detect an obstacle; and
a controller, configured to cause the vehicle to move in accordance with an instruction received via the communication circuit,
wherein
when the obstacle sensor detects an obstacle on a traveling path of the vehicle, the controller notifies presence of the obstacle to an outside via the communication circuit.

2. The vehicle of claim 1, wherein
the vehicle receives the instruction from a management device of a navigation management system via the communication circuit; and
the controller notifies presence of the obstacle to the management device via the communication circuit.

3. The vehicle of claim 1, wherein
the controller notifies presence of the obstacle to another vehicle via the communication circuit.

4. The vehicle of claim 1, wherein
when the obstacle sensor detects the obstacle, the controller alters the traveling path to avoid the obstacle, and notifies the traveling path after being altered to the outside via the communication circuit.

5. The vehicle of claim 1, wherein
when the obstacle sensor no longer detects the obstacle after a notification of presence of the obstacle to the outside, the controller notifies disappearance of the obstacle to the outside via the communication circuit.

6. The vehicle of claim 2, wherein
when the obstacle sensor no longer detects the obstacle after a notification of presence of the obstacle to the outside, the controller notifies disappearance of the obstacle to the outside via the communication circuit.

7. The vehicle of claim 3, wherein
when the obstacle sensor no longer detects the obstacle after a notification of presence of the obstacle to the outside, the controller notifies disappearance of the obstacle to the outside via the communication circuit.

8. The vehicle of claim 4, wherein
when the obstacle sensor no longer detects the obstacle after a notification of presence of the obstacle to the outside, the controller notifies disappearance of the obstacle to the outside via the communication circuit.

9. A management device for managing navigation of a plurality of vehicles that are capable of moving autonomously, the management device comprising:
a first communication circuit configured to communicate with each of the plurality of vehicles; and
a processing circuit configured to determine a traveling path for each vehicle and to transmit an instruction indicating the traveling path to each vehicle via the first communication circuit,
wherein each vehicle comprises:
a second communication circuit;
an obstacle sensor, configured to detect an obstacle; and
a controller, configured to cause the vehicle to move in accordance with the instruction received via the second communication circuit, wherein when the obstacle sensor detects an obstacle on the traveling path, the controller notifies presence of the obstacle to an outside via the second communication circuit;
wherein upon receiving a notification indicating presence of the obstacle from any one of the plurality of vehicles, the processing circuit indicates presence of the obstacle on a display.

10. The management device of claim 9, further comprising:
a storage device, configured to store data of a map,
wherein
the map is displayed on the display;
at least one of the plurality of vehicles transmits information indicating a position of the obstacle; and
the processing circuit indicates presence of the obstacle at the position on the map where the obstacle is present.

11. The management device of claim 10, wherein
the processing circuit refers to the map, determines an avoidance path for avoiding the obstacle, and indicates the avoidance path on the display.

12. The management device of claim 11, wherein
the processing circuit transmits, via the first communication circuit, an instruction indicating the avoidance path to the vehicle that has transmitted the information indicating the position of the obstacle.

13. The management device of claim 10, wherein
when the obstacle is present on the traveling path of another vehicle other than the vehicle that has transmitted the information indicating the position of the obstacle, the processing circuit determines an avoidance path for avoiding the obstacle on the traveling path of the other vehicle and transmits, via the first communication circuit, an instruction indicating the avoidance path to the other vehicle.

14. The management device of claim 9, wherein
upon receiving a notification indicating disappearance of the obstacle from the vehicle that has transmitted the notification indicating presence of the obstacle, the processing circuit clears an indication of presence of the obstacle from the display.

15. The management device of claim 12, wherein
upon receiving a notification indicating disappearance of the obstacle from the vehicle that has transmitted the notification indicating presence of the obstacle, the processing circuit clears an indication of presence of the obstacle from the display.

16. The management device of claim 12, wherein
upon receiving a notification indicating disappearance of the obstacle from the vehicle that has transmitted the notification indicating presence of the obstacle, the processing circuit cancels the avoidance path having been determined.

17. The management device of claim 9, further comprising:
the display.

18. The management device of claim 15, further comprising:
the display.

19. The management device of claim 16, further comprising:
the display.

20. A vehicle management system, comprising:
a plurality of vehicles that are capable of moving autonomously;
a management device, configured to manage navigation of the respective plurality of vehicles; and
a display,
wherein
the management device comprises:
a first communication circuit, configured to communicate with each of the vehicles; and
a processing circuit, configured to determine a traveling path for each vehicle and to transmit an instruction indicating the traveling path to each vehicle via the first communication circuit;
wherein each vehicle comprises:
a second communication circuit;
an obstacle sensor, configured to detect an obstacle; and
a controller, configured to cause the vehicle to move in accordance with the instruction received via the second communication circuit, wherein, when the obstacle sensor detects an obstacle on the traveling path, the controller notifies presence of the obstacle to an outside via the second communication circuit;
wherein upon receiving a notification indicating presence of the obstacle from any one of the plurality of vehicles, the processing circuit indicates presence of the obstacle on the display.
